(19) United States
(12) Patent Application Publication
(10) Pub. No.: US 2009/0189837 A1
(43) Pub. Date: Jul. 30, 2009

(54) LIQUID CRYSTAL DISPLAY

(75) Inventor: Nobuyasu Yamagishi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Minato-ku (JP)

(21) Appl. No.: 12/064,872

(22) PCT Filed: Aug. 25, 2006
(86) PCT No.: PCT/JP2006/317286

§ 371 Date: Feb. 26, 2008

(30) Foreign Application Priority Data
Aug. 26, 2005 (JP) 2005-246315
Dec. 5, 2005 (JP) 2005-350909

(51) Int. Cl. G09G 3/36

(52) U.S. Cl. 345/87

(57) ABSTRACT

An liquid crystal display includes a liquid crystal panel to which an image signal is applied, the liquid crystal panel including a liquid crystal molecule, and the liquid crystal display displaying an image based on the image signal by performing an active matrix driving, wherein a frequency of an image display in a one field period is higher than 60 Hz, the one field period being a time required for displaying the image, and a rising response time of the liquid crystal molecule is shorter than a hold time of the image signal in the one field.

### TECHNICAL FIELD

The present invention relates to an active matrix liquid crystal display having high performance in displaying a moving picture.

### BACKGROUND ART

Recently, the display performance of liquid crystal displays utilizing a liquid crystal panel has been significantly improved through improvements in contrast and mitigation of viewing angle dependency, which has been accompanied by improvements in production techniques such as increases in the size of substrates and techniques for reducing defect density. As a result, there is increasing use of such displays in wide screen televisions. The capability of displaying moving pictures is a prerequisite for the use of such displays in wide screen televisions, and high moving picture displaying performance is required because an image moves a greater distance in a unit time the greater the screen is.

Further, since the resolution of broadcast images is increasing as a result of the trend toward Hi-Vision broadcasting, a blur of a moving picture being displayed is becoming more noticeable. Higher performance in displaying moving pictures is required in light of the full implementation of Hi-Vision broadcasting in the future.

However, liquid crystal panels have a problem in moving picture displaying performance for two major causes described below. First, the panels are as slow as ten and a few ms in response speeds representing the time from the beginning of a rise of liquid crystal molecules until the end of the rise and the time from the beginning of a fall of the liquid crystal molecules until the end of the fall. Second, the panels employ the hold display method in which an image is displayed with a predetermined luminance that is held constant for one field period as a time required for displaying the image (displays used in liquid crystal televisions are of the hold-display active matrix type). Therefore, a resultant image gives a feel of incompatibility to human vision and appears with a blur when compared to impulse display as seen on CRTs.

FIG. 8A illustrates a response waveform of an ordinary liquid crystal panel, and FIG. 8B illustrates a response waveform of an ordinary CRT. Both of the figures illustrate a case in which white is displayed for four fields during display of black (see IDW98, p. 823, T. Kurita).

As countermeasures against the first cause of the problem, efforts for optimization are attempted including the adoption of liquid crystal materials having lower viscosity to allow liquid crystal molecules to move more easily and the reduction of liquid crystal cell gaps to increase the strength of electric fields. Further, the OCB (optically compensated bent) mode is employed, in which liquid crystal molecules in a liquid crystal cell are aligned in a bent configuration to allow the liquid crystal molecules to move more quickly, and which has successfully increased the response speed of liquid crystals to about 5 ms that is sufficiently shorter than one field period (16.7 ms). It should be noted that liquid crystal displays in the OCB mode are driven at 60 Hz in general.

The response speed of a liquid crystal is generally defined as follows. It is assumed that luminance A at the time of display of black and luminance B at the time of display of white are plotted as states of 0% and 100%, respectively, on a curve of transitions between the luminance A and the luminance B as illustrated in FIG. 2. The time required for a transition of luminance from 10% to 90% is defined as a rising response time τr, and the time required for a transition from 90% to 10% is defined as a falling response time τd.

In an intention to mitigate the problem with hold display that is the second cause, simulated impulse display has been conceived (JP-A-2001-268603 (the term “JP-A” as used herein means an “unexamined published Japanese patent application)), in which impulse display is simulated by switching display on a liquid crystal panel to insert display of black in one field period (JP-A-2001-42282) or turning a backlight on and off (JP-A-2002-91400), and the display method is employed in liquid crystal displays of some wide screen televisions.

As another approach to the mitigation of the above-described problem with the hold display, studies have been started on methods of improving moving picture displaying performance by simulating continuous display through the adoption of driving at a high frame rate (JP-A-2004-117758) in which a high driving frequency is employed to shorten the one field period (to shorten the one field period; it is proposed to set a frequency of 90 Hz or 120 Hz where a normal frequency is 60 Hz).

### DISCLOSURE OF THE INVENTION

However, moving picture displaying performance cannot be sufficiently improved by taking the above-described measures, and problems are occurring on moving pictures in practice including insufficient mitigation of blurs and the occurrence of double contours.

When high frame rate driving at a driving frequency higher than 60 Hz is used in combination with the insertion of black display as described above, the effect of improving moving picture displaying performance cannot be sufficiently achieved unless the response speed of the liquid crystal is properly matched with the driving waveform.

The invention has been made taking the above-described situations into consideration, and it is an object of the invention to provide a liquid crystal display (hereinafter also simply referred to as “an active matrix liquid crystal display”) which can achieve dramatically improved moving picture displaying performance without any degradation of a moving picture such as a blur or double contour when the moving picture is displayed.

The above-described object of the invention is achieved by the configurations described below.
(1) An liquid crystal display including a liquid crystal panel to which an image signal is applied, the liquid crystal panel including a liquid crystal molecule, and the liquid crystal display displaying an image based on the image signal by performing an active matrix driving, wherein a frequency of an image display in a one field period is higher than 60 Hz, the one field period being a time required for displaying the image, and a rising response time of the liquid crystal molecule is shorter than a hold time of the image signal in the one field.

In this liquid crystal display, high frame rate driving is employed to make the image display frequency for one field period higher than 60 Hz, and the rising response time of liquid crystal molecules in the liquid crystal panel is made shorter than the hold time of the image signal in one field period. As a result, a response of the liquid crystal is completed within one frame to eliminate any influence of the same on the next field period, which makes it possible to display a moving picture accurately with a reduced possibility of a signal error.
(2) The liquid crystal display as described in the item (1), wherein the one field period includes a black display period being a time for displaying a black display.

The liquid crystal display can perform simulated impulse display similar to the impulse display which has high moving picture displaying performance by providing a black display period in one field period.
(3) The invention provides an active matrix liquid crystal display according to the item (2), wherein a falling response time of the liquid crystal molecule is shorter than the black display period.

The liquid crystal display can sufficiently display a black level without any residual image because the falling response time of the liquid crystal molecules is shorter than the black display period in the one field period. Further, the starting luminance of the next field period can be made sufficiently low.
(4) The liquid crystal display as described in the item (3), wherein the black display comprises a black display caused by switching an image signal supplied to the liquid crystal panel.

In the liquid crystal display, a black display period can be formed by switching an image signal supplied to the liquid crystal panel.
(5) The liquid crystal display as described in the item (3), wherein the black display comprises a black display caused by turning off a backlight of the liquid crystal display.

In the active matrix liquid crystal display, a black display period can be formed by displaying black by turning the backlight of the liquid crystal panel off.
(6) The liquid crystal display as described in the item (5), wherein the rising response time is shorter than the black display period.

The liquid crystal display can sufficiently display a white level because the rising response time of the liquid crystal molecules is shorter than the black display period in the single frame.
(7) The liquid crystal display as described in any of the items (1) to (6), wherein the falling response time is shorter than the rising response time.

In this liquid crystal display, luminance can be reduced to a sufficient black level when black is displayed in a second half of a field period. As a result, substantially no blur occurs on a moving picture even when the moving picture displayed makes quick movements, and high moving picture displaying performance can therefore be achieved.
(8) The liquid crystal display as described in the item (7), wherein the liquid crystal panel displays the black display by being applied a voltage and displays a white display by stopping an application of the voltage.

In this liquid crystal display, black is displayed by applying a higher voltage where driving must be performed at a higher response speed by taking advantage of such general characteristics of a liquid crystal panel that a transition from a low potential to a high potential occurs at a higher response speed, which allows black can be easily displayed at a higher speed than white.
(9) The liquid crystal display as described in any of the items (1) to (8), wherein the liquid crystal molecules have a bend alignment.

In this liquid crystal display, the use of an OCB mode liquid crystal allows high speed response to be achieved easily.

In an liquid crystal display according to the invention, a liquid crystal panel having a high liquid crystal response speed is driven at a high frame rate. As a result, a moving picture is displayed with substantially no image degradation attributable to a blur or double contour of the moving picture even when the picture moves quickly. It is therefore possible to achieve high moving picture displaying performance. When black display is inserted using high frame rate driving, the level of the displayed black is decreased to a sufficiently low luminance by providing the liquid crystal with such response characteristics that a falling response time is shorter than a rising response time. It is therefore possible to display a high moving picture with high performance by preventing image degradation as described above.

### BRIEF DESCRIPTION OF THE DRAWINGS

The invention disclosed herein will be understood better with reference to the following drawings of which:

FIG. 1 is a schematic view that illustrates a configuration of a liquid crystal display in a first embodiment of the invention;

FIG. 2 is a graph that illustrates a response waveform obtained when white is displayed in four field periods on a liquid crystal panel in the first embodiment;

FIG. 3 is a graph that illustrates a response waveform obtained when white is displayed in four field periods on an ordinary liquid crystal panel;

FIGS. 4A and 4B are graphs that illustrate response waveforms of liquid crystal panels obtained when white is displayed. FIG. 4A illustrates a response waveform of a liquid crystal panel in a second embodiment, and FIG. 4B illustrates a response waveform obtained at an ordinary response speed;

FIGS. 5A and 5B are graphs that illustrate response waveforms of liquid crystal panels obtained when white is displayed. FIG. 5A illustrates a response waveform of a liquid crystal panel in a third embodiment, and FIG. 5B illustrates a response waveform obtained at an ordinary response speed.

FIG. 6 is a configuration diagram that illustrates a configuration of a liquid crystal display in a fourth embodiment;

FIGS. 7A and 7B are graphs that illustrate response waveforms of liquid crystal panels obtained when white is displayed according to the fourth embodiment; and

FIGS. 8A and 8B are graphs that illustrate a response waveform. FIG. 8A is a graph that illustrates a response waveform of an ordinary liquid crystal panel, and FIG. 8B is a graph that illustrates a response waveform of an ordinary CRT.

### BEST MODE FOR CARRYING OUT THE INVENTION

Preferred embodiments of an active matrix liquid crystal display according to the invention will now be described in detail with reference to the drawings.

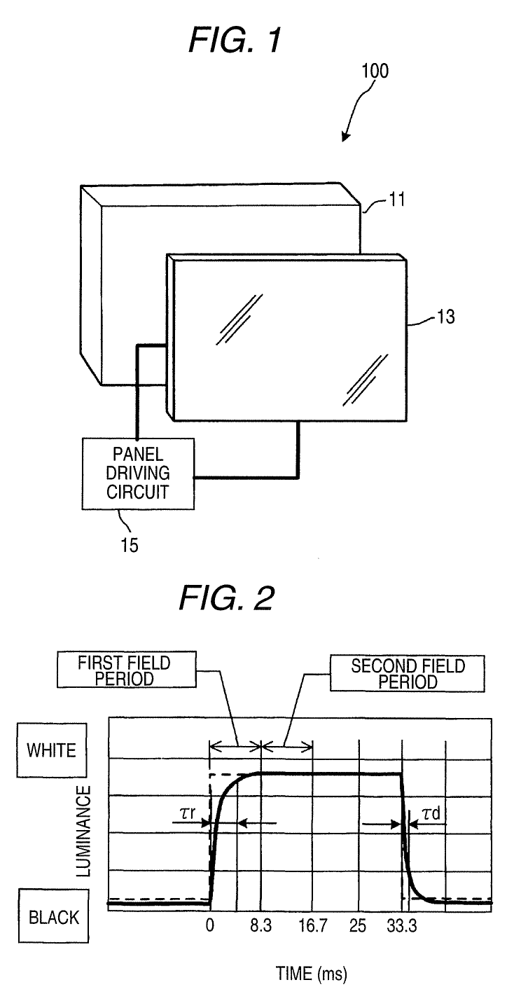

FIG. 1 is a schematic view that illustrates a configuration of a liquid crystal display according to a first embodiment of the invention.

A liquid crystal display 100 is constituted by a flat backlight unit 11 and a liquid crystal panel 13, and a panel driving circuit 15 is connected to an electrode of the liquid crystal panel 13 to apply a signal to the same. The panel driving circuit 15 performs active matrix driving of the liquid crystal panel 13.

The liquid crystal panel 13 employs a liquid crystal of the so-called OCB mode in which liquid crystal molecules are aligned in a bent configuration and in which display is performed by varying the value of retardation provided by the liquid crystal by varying the curvature of the bend through an increase or decrease in an applied voltage.

An OCB type liquid crystal display used as the liquid crystal panel 13 of the present embodiment comprises a liquid crystal cell and two polarizers provided on both sides of the same, although not illustrated. The liquid crystal cell comprises two electrode substrates bearing a liquid crystal between them. One optical compensation film is provided between the liquid crystal cell and one of the polarizers. Alternatively, two films may be provided between the liquid crystal cell and both of the polarizers. When the optical compensation films are used as a protective film for the polarizers, the polarizers will serve also as optical compensation films, which is preferable in reducing the thickness and weight of the liquid crystal display.

In liquid crystal displays according to an OCB type display method employ a liquid crystal cell in a bent alignment mode in which calamitic liquid crystal molecules in upper and lower parts of the liquid crystal cell are aligned substantially in opposite directions (symmetrically). For example, such cells are disclosed in the specifications of U.S. Pat. Nos. 4,583,825 and 5,410,422. A liquid crystal cell in the bent alignment mode has an optical compensation function in itself because calamitic liquid crystal molecules are aligned symmetrically between upper and lower parts of the liquid crystal cell. Therefore, such a liquid crystal mode is referred to as an OBC (Optically Compensatory Bend) liquid crystal mode. A liquid crystal display in the bent alignment mode is advantageous in that it has a high response speed.

FIG. 2 illustrates a response waveform of the liquid crystal panel 13 of the present embodiment observed when white is displayed. In FIG. 2, a response waveform representing changes in the intensity of light is indicated by a solid line, and the voltage signal applied is indicated by a broken line. As illustrated, the response of the liquid crystal panel 13 is characterized by a rising response time rτ=4 ms and a falling response time τr=1 ms. That is, the liquid crystal panel 13 has such a characteristic that a falling response time of liquid crystal molecules is shorter than a rising response time of the same.

Referring to measures against blurring of a moving picture attributable to hold display taken in the liquid crystal panel 13 of the present embodiment, the driving frequency of the liquid crystal panel 13 is set at 120 Hz that is twice 60 Hz used for normal driving. In this case, a hold time in one field period as a time required for displaying the image is 8.3 ms, which means that the liquid crystal panel 13 is sufficiently higher in response speed than ordinary liquid crystal panels. A rise and a fall of liquid crystal molecules are completed within one field period.

The moving picture displaying performance of the liquid crystal display 100 of the present embodiment was measured using MPRT-1000 which is a moving picture displaying performance evaluation apparatus manufactured by Otsuka Electronics Co., Ltd. (Document: IDW03, p. 1483, K. Oka). The liquid crystal display of the present embodiment had moving picture displaying performance or an MPRT value of 8 ms.

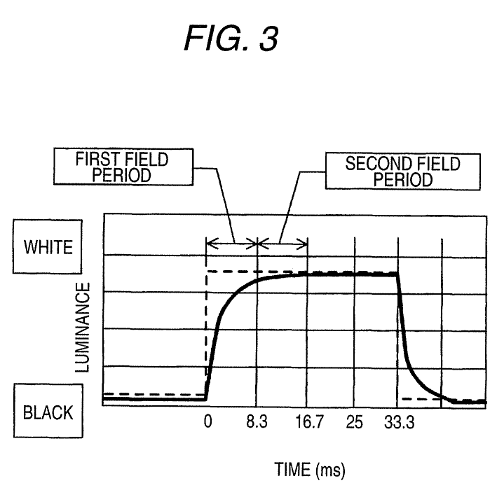

FIG. 3 illustrates a response waveform of an ordinary liquid crystal panel in a case in which white is displayed in each of four field periods. As illustrated in FIG. 3, a rise and a fall of liquid crystal molecules are so slow as to take a time in the excess of one field period when compared to those in the liquid crystal panel 13 of the present embodiment in which a rise and a fall of liquid crystal molecules can be completed within one field period. A liquid crystal panel having such an ordinary response speed had moving picture displaying performance or an MPRT value of 12 ms when it had a rise time τr of 12 ms and a fall time τr of 15 ms. When the ordinary liquid crystal panel was driven at 60 Hz, it had an MPRT value of 15 ms. It will be understood from above that the liquid crystal panel 13 of the present embodiment can achieve moving picture displaying performance higher than that achievable with other ordinary configurations.

Further, when the liquid crystal panel 13 of the present embodiment is driven, a response of liquid crystal molecules completes within one field period and does not affect the next field, which allows a moving picture to be accurately displayed with reduced possibility of a signal error. Therefore, in the case of an active matrix liquid crystal display employing the liquid crystal panel 13 of the present embodiment, a moving picture has substantially no image degradation attributable to a blur or double contour even when the picture is displayed with quick movements because the liquid crystal panel having a high liquid crystal response speed is driven at a high frame rate. It is therefore possible to achieve high moving picture displaying performance.

A second embodiment of an active matrix liquid crystal display according to the invention will now be described. The present embodiment is aimed at a further improvement in moving picture displaying performance from that achievable in the first embodiment.

The liquid crystal display of the present embodiment has the same configuration as that illustrated in FIG. 1 or the first embodiment comprising the flat backlight 11 and the liquid crystal panel 13. The present embodiment employs a liquid crystal panel 13 in the OCB mode having high speed response performance similar to that in the first embodiment. Further, the display frequency is 120 Hz (one field period is 8.3 ms) which is the same as in the first embodiment.

In the present embodiment, a black display signal is applied to the liquid crystal panel 13 in the second half of one field period to display black on the liquid crystal panel. Thus, a black display period as a time for displaying a black display is provided in one field period, and it is therefore possible to perform simulated impulse display which is similar to impulse display that provides high moving picture displaying performance.

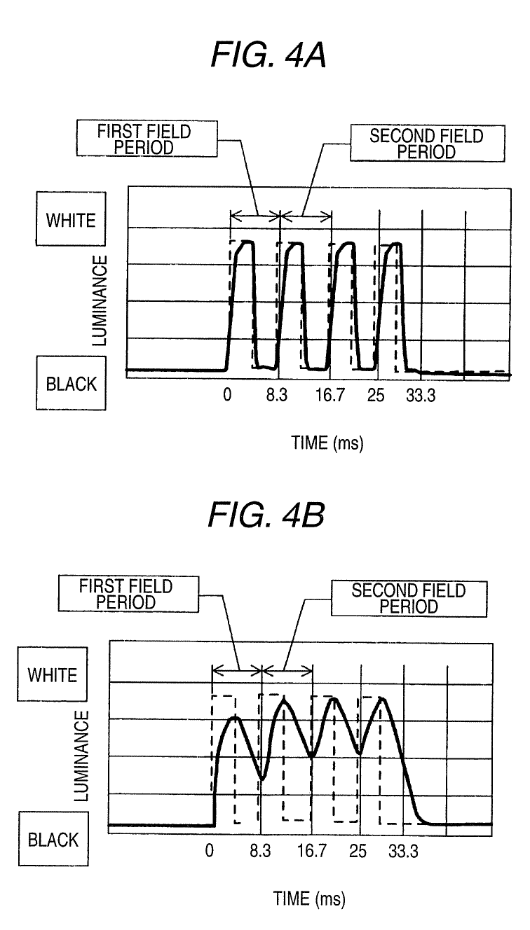

FIGS. 4A and 4B illustrate response waveforms of liquid crystal panels obtained when white is displayed according to the present embodiment. FIG. 4A illustrates the waveform of the liquid crystal panel 13 of the present embodiment, and FIG. 4B illustrates a waveform at an ordinary response speed. In both cases, white is displayed in four field periods while black is displayed, and the signals applied are indicated by broken lines.

As illustrated in FIGS. 4A and 4B, a white display signal is applied in a period that occupies the first 50% of each field period (which is 4.1 ms in the present embodiment), and a black display signal is applied in a period that occupies that second 50% of each field period (which is 4.1 ms in the present embodiment). The applied signals in FIGS. 4A and 4B are identical.

Although the signals are identical, resultant response waveforms are significantly different. In FIG. 4 illustrating the liquid crystal panel 13 of the present embodiment, since both rise and fall of the liquid crystal molecules of the liquid crystal panel 13 have a response speed of 4 ms or less, a rise is completed within 4.1 ms or the white display signal application period in the first half of a field (a hold time in the present embodiment). Thus, the white level is sufficiently displayed. Further, a fall is completed within 4.1 ms or the black display signal application period in the second half, and luminance is thus reduced to the black level in the second half of each field period. Therefore, it maybe concluded that the liquid crystal panel 13 of the present embodiment is successful in achieving simulated impulse display.

On the contrary, when an ordinary liquid crystal panel is used as illustrated in FIG. 4B, since the response of the liquid crystal panel is slow, the response waveform indicates that the white level cannot be sufficiently achieved when white is displayed and that the reduction to the black level is insufficient when black is to be displayed. The waveform indicates that simulated impulse display is not performed sufficiently.

The moving picture displaying performance of the liquid crystal display of the present embodiment was measured using MPRT-1000 as described above, and an MPRT value of 4 ms was measured. The value was 10 ms when the ordinary liquid crystal panel illustrated in FIG. 4B was used.

As described above, the configuration of the present embodiment makes it possible to provide a liquid crystal display having very high moving picture displaying performance. In order to perform insertion display of black using a black signal on the basis of high frame rate driving, a rise and fall of the liquid crystal panel must be completed within one field period. It is therefore required to employ a liquid crystal panel responding at a high speed.

When a black display period occupying 50% of one frame is to be inserted at a driving frequency of 120 Hz as in the present embodiment, both rise and fall of the liquid crystal panel must terminate in 4 ms or less.

While the black display period inserted occupies 50% of each frame in the present embodiment, a change may be made as occasion demands. However, a black insertion period longer than needed will reduce brightness and hold time and will result in a further reduction in brightness when the period is shorter than the rise time of the liquid crystal.

When the black insertion period is shortened than needed below the fall time of the liquid crystal, black cannot be sufficiently inserted, and the effect of improving moving picture displaying performance using simulated impulses is significantly reduced. In this case, since a change occurs in the starting luminance of the next field, the second field period will be higher in luminance than the first field period, and the rising period therefore resides in two field periods (see FIG. 4B). This results in a significant reduction in moving picture displaying performance. Therefore, the black insertion period must be properly set taking the above-described situation into consideration.

A third embodiment of an active matrix liquid crystal display according to the invention will now be described. The liquid crystal display of the present embodiment has the same configuration as that of the second embodiment illustrated in FIG. 4 and employs an OCB mode liquid crystal panel. Further, the display frequency is 120 Hz (one field period is 8.3 ms) which is the same as in the first embodiment.

In the present embodiment, black is displayed again on a liquid crystal panel 13 by applying a black display signal in the second half of one field period. Thus, simulated impulse display is performed, in which a back display period is provided in one field period.

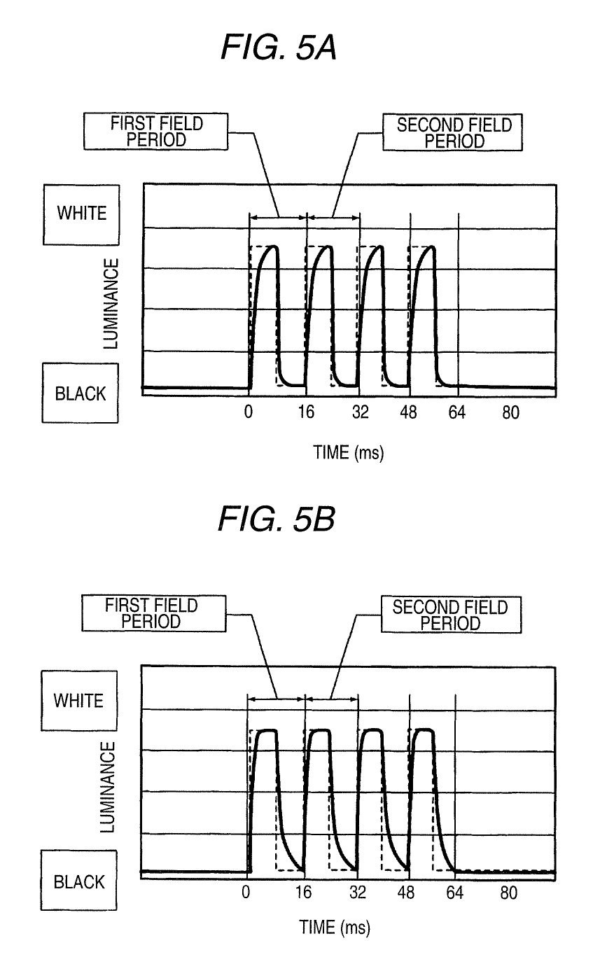

FIG. 5A and FIG. 5B illustrate response waveforms of liquid crystal panels obtained when white is displayed according to the present embodiment. FIG. 5A illustrates the waveform of the liquid crystal panel 13 of the present embodiment, and FIG. 5B illustrates a waveform obtained when white is displayed using a liquid crystal panel having a response speed, as an example of an ordinary response speed, resulting in a rising response time τr=1 ms and a falling response time τr=4 ms. In both cases, white is displayed in four fields while black is displayed, and the signals applied are indicated by broken lines.

As illustrated in FIGS. 5A and 5B, a white display signal is applied in a period that occupies the first 50% of each field periods (which is 4.1 ms in the present embodiment), and a black display signal is applied in a period that occupies that second 50% of each field periods (which is 4.1 ms in the present embodiment). The applied signals in FIGS. 5A and 5B are identical.

Although the signals are identical, resultant response waveforms are significantly different. Referring to FIG. 5A, the falling response time τd of the liquid crystal panel is shorter than the rising response time τr, and a fall is sufficiently completed within 4.1 ms that is the application time of a black display signal. Further, luminance is sufficiently reduced to the black level in the second half of each field periods. Therefore, simulated impulse display is achieved properly in the present embodiment.

On the contrary, referring to FIG. 5B, although a fall is completed within 4.1 ms that is the application time of a black display signal, the black level in the response waveform is slightly higher than that in FIG. 5A, and the insertion of black in the second half of one field period is insufficient.

The moving picture displaying performance of the liquid crystal display of the present embodiment was measured using MPRT-1000 as described above, and an MPRT value of 4 ms was measured in the case illustrated in FIG. 5A. The value was 6 ms when the ordinary liquid crystal panel illustrated in FIG. 5B, which had reverse rising and falling response characteristics, was used.

As thus described, when liquid crystal panels having response times τr and τd totaling equally at 5 ms are used, the panel having a shorter falling response time τd can achieve higher moving picture displaying performance. This is advantageous especially when insertion display of black is performed using a black signal on the basis of high frame rate driving. On the liquid crystal display of the present embodiment utilizing the applied signal illustrated in FIG. 5A, substantially no blur of a moving picture is observed even when the picture moves quickly, and high displaying performance can therefore achieved.

Referring to a method of obtaining a liquid crystal panel having a falling response time τd shorter than a rising response time τr, it is advantageous to employ an NW (normally white) device configuration in which black is displayed when a high voltage is applied because a transition from a low potential to a high potential occurs at a higher response speed in a normal liquid crystal panel. That is, black is displayed by applying a higher voltage where driving must be performed at a higher response speed by taking advantage of such general characteristics of an ordinary liquid crystal panel that a transition from a low potential to a high potential occurs at a higher response speed. Thus, black can be easily displayed at a higher speed than white.

A fourth embodiment of an active matrix liquid crystal display according to the invention will now be described. The present embodiment achieves a further improvement in moving picture displaying performance from that of the first embodiment.

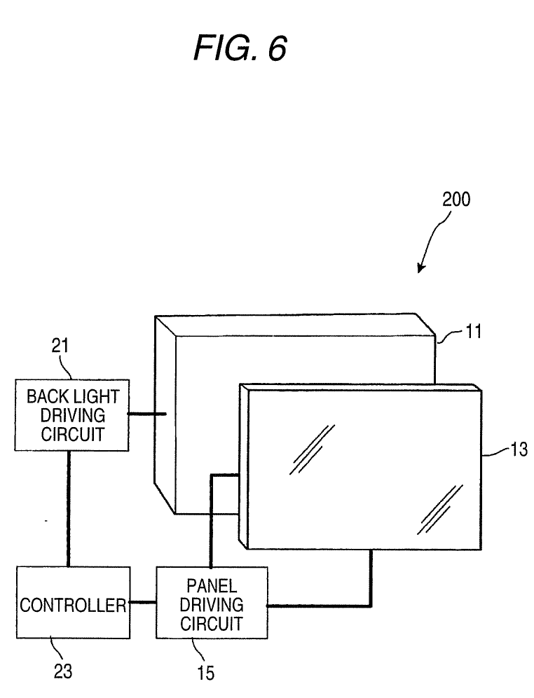

FIG. 6 illustrates a configuration of a liquid crystal display 200 of the present embodiment. The liquid crystal display 200 of the present embodiment includes a backlight driving circuit 21 for turning a flat backlight unit 11 and a controller 23 for controlling timing associated with a liquid crystal panel 13 (see JP-A-2002-221701). Referring to the liquid crystal panel 13, an OCB mode panel having the same high speed response performance as that in the first embodiment is used. The display frequency of the liquid crystal panel 13 is 120 Hz (one field period is 8.3 ms) which is the same as in the first embodiment.

In the liquid crystal display 200 of the present embodiment, the backlight 11 is kept off for 4.1 ms in the first half of one field period to provide a black display period in the one field period. Thus, simulated impulse display is performed to simulate impulse display which provides high moving picture displaying performance.

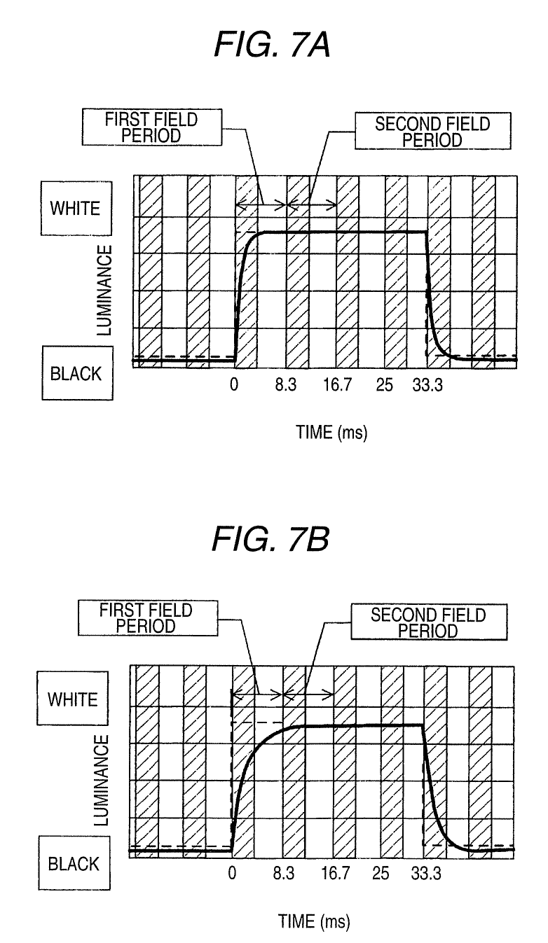

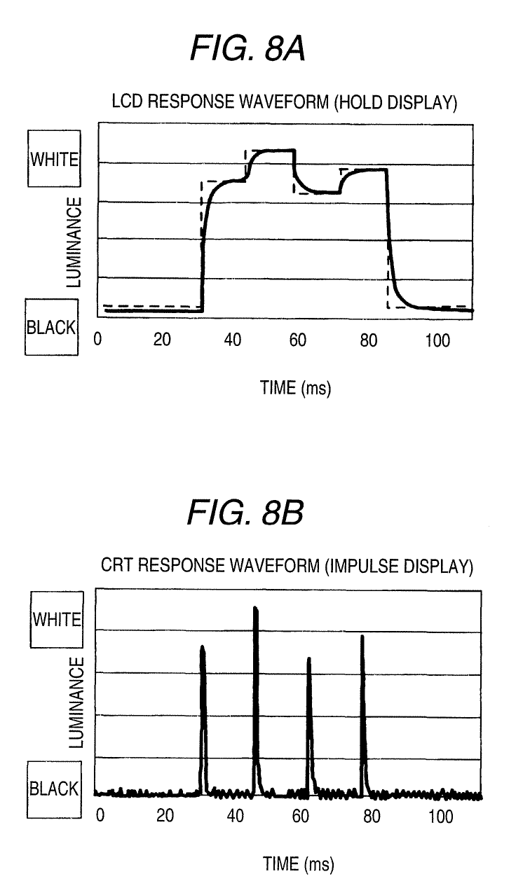

FIG. 7A illustrates response waveforms of liquid crystal panels obtained when white is displayed according to the present embodiment. In each of the figures, the response waveform of the liquid crystal is indicated by a solid line; the signal applied to the liquid crystal panel is indicated by a broken line; and an off-period of the backlight is indicated by oblique lines. As illustrated, simulated impulse display is achieved by keeping the backlight off during a period occupying the first 50% of one field period.

As illustrated in FIG. 7A, liquid crystal molecules have already risen to display a high or white level before the time when the backlight is turned on in the second half of the first field period, and the waveform remains unchanged in the subsequent field periods. Therefore, the rise is completed in the period that is one half of the first field period(which is 4.1 ms in the present embodiment).

FIG. 7B illustrates a response waveform obtained when a liquid crystal panel having slightly higher response speeds (a rising speed τr=8 ms and a falling speed τr=7 ms). A backlight is turned on and off to perform simulated impulse display similar to that illustrated in FIG. 7A, but it will be understood that the liquid crystal is still on the rise when the backlight is on in the second half of the first field period and that the luminance of white is slightly lower than that in the next field period. The difference in luminance between the first and second field periods means that the rise has been completed in the second field period. Specifically, the rise is completed in the second half of the second field period. In this case, the rise took 12.4 ms to be completed.

The moving picture displaying performance of the liquid crystal display of the present embodiment was measured using MPRT-1000 as described above, and an MPRT value of 4 ms was measured. The value was 12 ms when the ordinary liquid crystal panel illustrated in FIG. 7B was used.

In the case of FIG. 7B, not only the moving picture displaying performance is low, but also a double contour is generated in the case of a moving picture in a pattern having a clear contour. Such a problem is more significant on a liquid crystal panel having a low response speed. In such a case, it is therefore desirable to replace the panel with a liquid crystal panel having a higher response speed, and a rise and fall of the liquid crystal panel must be completed within a period in which the backlight is off. That is, the rising and falling response times of the liquid crystal panel 13 are set shorter than a black display period in one frame.

As described above, the liquid crystal display 200 of the present embodiment can be provided as a liquid crystal display having very high moving picture displaying performance.

While the backlight off period occupies 50% of one field period in the present embodiment, it may be changed may as occasion demands. However, a backlight off period longer than needed will reduce brightness. When the backlight off period (black insertion period) is made shorter than needed and a hold time, in which the backlight is off, is consequently reduced below the rise time of the liquid crystal, the rise of the liquid crystal is completed in the second field period as described above. As a result, moving picture displaying performance is significantly reduced, and a double contour maybe generated. Therefore, the backlight off period must be properly set taking the above-described situation into consideration.

Although a driving frequency of 120 Hz is employed in the three embodiments described above, it may be changed as occasion demands. Higher moving picture displaying performance will be achieved by employing a higher frame rate. It is therefore desirable to use a high speed liquid crystal panel such as an OCB mode panel and to set the frame rate and the ratio at which black display periods are inserted according to the response speed.

Although no description was given above on specific measures associated with the improvement in the response speed of the liquid crystal panel 13 in the above-described embodiments, overdriving (see JP-A-2000-231091 for example) may be adopted to generate a compensation signal which is superimposed on a driving voltage waveform, in addition to the use of an OCB mode liquid crystal as proposed above. Specifically, a compensation signal is superimposed on a driving voltage waveform to temporarily set a voltage higher than a predetermined constant driving voltage, which makes it possible to increase a response speed and to prevent an overshoot of display luminance. In this case, when the waveform of the voltage applied is improved using overdriving, a setting is made such that the falling response time τd becomes shorter than the rising response time τr. When overdriving is employed, although the waveform of the signal applied will be slightly different from those in the embodiments, the operations and effects according to the invention can be equally achieved.

When a compensation signal for a response of liquid crystal molecules is applied using overdriving as described above, the period in which a constant voltage is held will be shortened. It is assumed in the context of the invention that a hold time includes the period of the compensation signal.

Although not described in the embodiment, the turning on/ff of a backlight described in the fourth embodiment may be advantageously combined with the second and third embodiments for the purposes of further improving moving picture displaying performance, reducing the level of black at the time of insertion of a black display period, and saving power.

The present application claims foreign priority based on Japanese Patent Application (JP 2005-246315) filed Aug. 26 of 2005, Japanese Patent Application (JP 2005-350909) filed Dec. 5 of 2005, the contents of which is incorporated herein by reference.

1. An liquid crystal display comprising a liquid crystal panel to which an image signal is applied, the liquid crystal panel including a liquid crystal molecule, and the liquid crystal display displaying an image based on the image signal by performing an active matrix driving,
wherein
a frequency of an image display in a one field period is higher than 60 Hz, the one field period being a time required for displaying the image, and
a rising response time of the liquid crystal molecule is shorter than a hold time of the image signal in the one field.

2. A liquid crystal display according to claim 1, wherein the one field period comprises a black display period being a time for displaying a black display.

3. A liquid crystal display according to claim 2, wherein a falling response time of the liquid crystal molecule is shorter than the black display period.

4. A liquid crystal display according to claim 3, wherein the black display comprises a black display caused by switching an image signal supplied to the liquid crystal panel.

5. A liquid crystal display according to claim 3, wherein the black display comprises a black display caused by turning off a backlight of the liquid crystal display.

6. A liquid crystal display according to claim 5, wherein the rising response time is shorter than the black display period.

7. A liquid crystal display according to claim 1, wherein the falling response time is shorter than the rising response time.

8. A liquid crystal display according to claim 7, wherein the liquid crystal panel displays the black display by being applied a voltage and displays a white display by stopping an application of the voltage.

9. A liquid crystal display according to claim 1, wherein the liquid crystal molecules have a bend alignment.
